(19) United States
(12) Patent Application Publication
(10) Pub. No.: US 2003/0081242 A1
(43) Pub. Date: May 1, 2003

(54) Printing system

(76) Inventors: Shell S. Simpson, Boise, ID (US); Ward S. Foster, Boise, ID (US); Kris R. Livingston, Boise, ID (US)

Correspondence Address: HEWLETT-PACKARD COMPANY, Intellectual Property Administration, P.O.Box 272400, Fort Collins, CO, 80527-2400, US

(21) Appl. No.: 10/000,707

(22) Filed: Oct. 31, 2001

(51) Int. Cl. G06F 15/00; G06F 13/00

(52) U.S. Cl. 358/1.15; 345/738; 345/740

(57) ABSTRACT

A computing system is described. The computing system includes a personal computer, a primary printer and an alternate printer all connected to a network. The primary printer is a multifunctional printing device and can be used for remote printing and walk-up copying. The primary printer can serve a first program to the personal computer upon request. The first program enables the personal computer to print a document using the primary printer. The first program further enables the computer to provide the user with an indication that document printing will be delayed due to intervention by a walk-up user. When such an event occurs, the user is given the option to print his/her document using the alternate printer.

### BACKGROUND

Today many printers are multi-functional devices. Some printers, for example, include a local scanner and allow for both remote printing and walk-up copying. An example of such a printer is described in the U.S. Pat. No. 6,026,258 entitled “METHOD FOR TEMPORARILY LOCKING OUT PRINT JOBS ON A NETWORK COPIER WHEN A COPIER USER IS PRESENT”. That patent is incorporated herein by reference.

According to remote printing, a remote user transmits a print job electronically to the printer over a communication link, such as a network. The printer responds by printing the job. According to walk-up copying, a walk-up user can walk-up to the printer with a document and use the scanner in order to make additional copies of the document.

For ease of discussion, a job submitted electronically over a network to a printer may be referred to as a “remote job”. A job submitted by a walk-up user may be referred to as a “copy job”. It is also noted that the phrase “print job” may refer to either a remote job or a copy job.

Some multi-functional printers allow a walk-up user to interrupt the processing of a remote job. After interrupting the remote job, the walk-up user can then submit his/her copy job.

The interruption of a remote job by a walk-up user can cause the remote user a problem. The remote user, for example, may not know with any certainty when the printer will be released by the walk-up user. In part this is due to the very nature of walk-up printing. A walk-up user, for example, may wish to copy multiple documents. Thus, a walk-up user may submit (during a single walk-up session) a stream of successive copy jobs. This can result in the printer being unavailable to process the remote user's job for a significant period of time.

### SUMMARY

According to one embodiment, the invention provides a computer implemented method. The computer is remotely connected to a first printer. The method may include, for example, the steps of: displaying a graphical user interface (GUI) that enables a first user of the computer to provide input for initiating the printing of a document using the first printer; and if the first printer is processing a copy job when the computer is displaying the GUI, then automatically providing the first user with an indication that the first printer is processing a copy job.

According to another embodiment, the invention provides a computer readable medium embodying a first program of instructions for causing a computer to perform method steps. The methods steps may include, for example, the steps of: in response to user input, initiating printing of a remote print job by a first printing device; and if the printing of the remote print job is interrupted by a walk-up user of the first printing device, then providing the first user with an indication that the printing of the remote print job has been interrupted by the walk-up user.

According to another embodiment, the invention provides a server. The server may include, for example, apparatus to receive a request from a computer over a network; and apparatus to respond to the request by transmitting a first program of computer readable instructions to the computer, the first program enabling the computer to:(i) display a GUI that enables a user of the computer to provide input for initiating the printing of a document using a first printer; and (ii) automatically display an indicator indicating the first printer is processing a print job if the first printer is presently processing a copy job when the GUI is displayed.

According to another embodiment, the invention provides a system. The system may include, for example, a client and a server. The server is operable to receive a first request from the client and to respond thereto by serving a first program of instructions to the client. The first program of instructions enables the client to:(i) display a GUI that enables a user of the computer to provide input for initiating the printing of a document using a first printing device; and (ii) automatically providing the user with an indication that the first printer is processing a copy job if the first printer is processing a copy job when the computer displays the GUI.

Other aspects and advantages of the present invention will become apparent from the following detailed description, taken in conjunction with the accompanying drawings, illustrating by way of example the principles of the invention.

### BRIEF DESCRIPTION OF THE DRAWINGS

FIG. 1A is a block diagram of a computing system that incorporates an embodiment of the invention;

FIG. 1B provides a physical representation of a primary printer in the system;

FIG. 2 is a flow diagram illustrating how a user of a PC in the system can make a job document;

FIG. 3 is a flow diagram illustrating the operation of the PC to request and run Web content;

FIG.4A and FIG. 4B is a flow diagram illustrating the operation of the PC under the direction of Web content received from the primary printer;

FIG. 5A provides an example of a GUI that may be displayed by the PC while operating under the direction of the Web content;

FIG. 5B provides an example of a copy-job alert page that may be displayed by the PC;

FIG. 6A provides an example of a job status page that may be displayed by the PC;

FIG. 6B provides an example of a job status page that may be displayed by the PC

FIG. 7 is a flow diagram illustrating the operation of the Web browser assuming a user selects a hyperlink referring to Web Content provided by an alternate printer; and

FIG. 8 is a flow diagram illustrating the operation of the PC under the direction of the Web content received from the alternate printer.

### DESCRIPTION

As used herein, the phrase “Web content” refers to a program of computer readable instructions that may be executed by a Web Browser. Thus, for example, Web content may be a set of instructions written in any of the following languages (the following is a non-exhaustive list): HTML, Java, JavaScript, C-Sharp code, etc.

Additionally, it is known in the art that Web pages often include one or more “hyperlinks”. Typically, a hyperlink is displayed on a Web page as a highlighted word or phrase. A hyperlink may also appear as a graphic. In order to activate a hyperlink, a user typically selects it by using a pointer device, such as a mouse.

It is also known in the art that hyperlinks may be configured to cause a computer to perform various functions. For example, a Web page (presently being displayed by a Browser) may include a hyperlink that refers to another Web page (target page) that is located on a remote server. Selecting the hyperlink causes the Browser to retrieve the target page from the remote server and to display it. This same hyperlink may also include parameters that are passed to the server when the target page is requested.

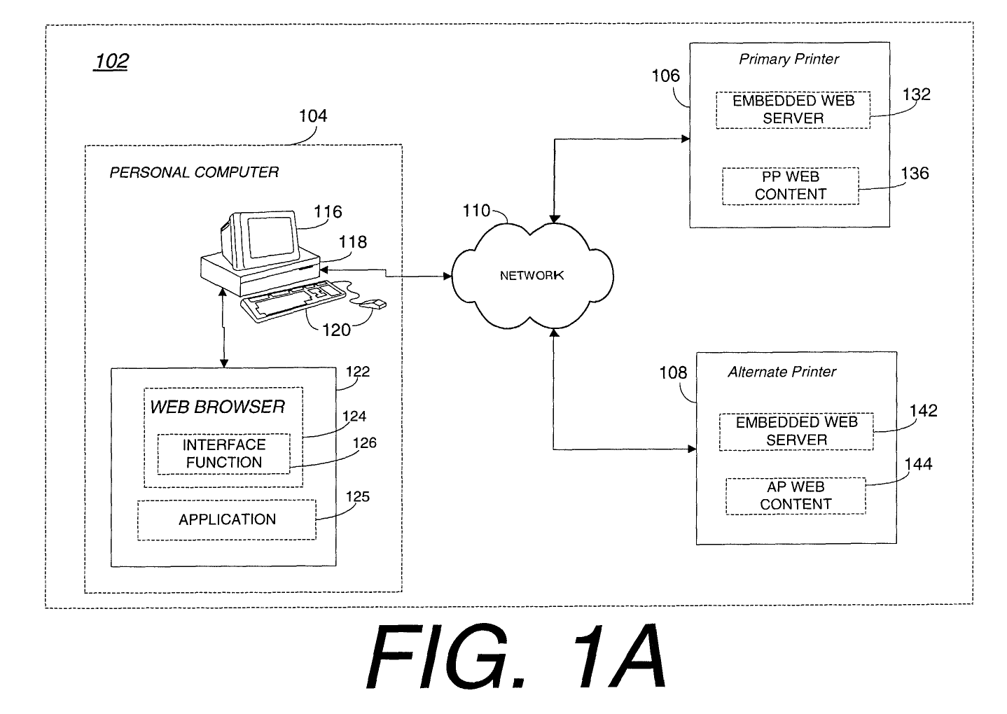

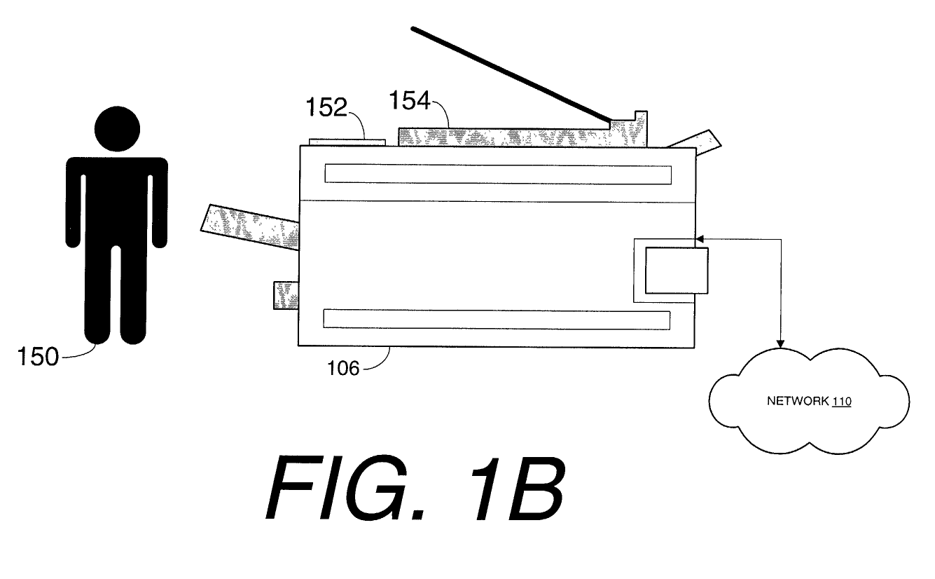

As shown in FIG. 1A, for purposes of illustration, the invention is embodied in a novel computing system 102. The computing system 102 includes a personal computer (PC) 104, a “primary” printer 106 and an “alternate” printer 108 all connected to a network 110. The network 110 may represent, for example, an intranet, a series of networks, the public Internet, a wireless network(s), etc., or some combination thereof.

FIG.1B provides a physical representation of the primary printer 106 in the present embodiment. Referring briefly to FIG. 1B, the primary printer 106 is a multifunctional printing device and can be used for remote printing and walk-up copying. As shown, the primary printer 106 includes a scanner device 154 and a control panel 152. A walk-up user 150 can make use of the scanner 154 to make copies of an existing document. A remote user (e.g., a user of the PC 104) can submit a remote job via the network 110.

For illustration purposes, it is assumed that while a remote job is being processed by the primary printer 106, a walk-up user can interrupt the remote job and submit a copy job. A walk-up user may interrupt a remote job by selecting an interrupt key from the control panel 152. Once a user submits a copy job, the primary printer 106 processes the copy job ahead of the remote job.

Referring again to FIG.1A, in this embodiment, the PC 104 runs a local operating system, such as a version of Windows or Windows NT. In order for a user to access the PC 104, the user first logs on. This involves the user establishing his/her online identity by inputting a user name and a password. For ease of discussion, a user presently logged into the PC 104 may be referred to as the “active user”.

In the present embodiment, there exists a special classification of electronic documents. Documents that fall into this classification are referred to herein as “job documents”. Each job document is linked to a user's online identity. A job document that is linked to a user's online identity may be referred to as being that user's “personal” job document. Each user of the PC 104, for example, can designate a different document to be his/her “personal” job document.

As shown, the PC 104 includes a display monitor 116, a processing unit 118, user input devices 120 and a memory 122. Stored in the memory 122 are a Web Browser 124 and a word processing application 125. The processing unit 118 can retrieve and execute these two applications upon receiving an appropriate request from the user. The Web Browser 124 enables the PC 104 to run Web content and function as a Web client in the system 102.

The Web browser 124 includes a program interface function (PI function) 126. Web content running in the browser 124 can call the PI function 126 in order to access the active user's personal job document.

It is noted that the call to invoke the PI function 126 is device independent and is defined by a standard. For ease of discussion, the call to invoke the PI function 126 may be referred to herein as the “get_job_doc” call. The standard that defines the call may be referred to herein as the “Web imaging” standard.

To illustrate the operation of the PI function 126, consider the following example. Assume user “A” designates document “A” to be his/her personal job document. User “B” designates document “B” to be his/her personal job document. Under these conditions, when user “A” is the active user, Web content will access document “A” by calling the PI function 126. When, however, user “B” is the active user, Web content will access document “B” by calling the PI function 126.

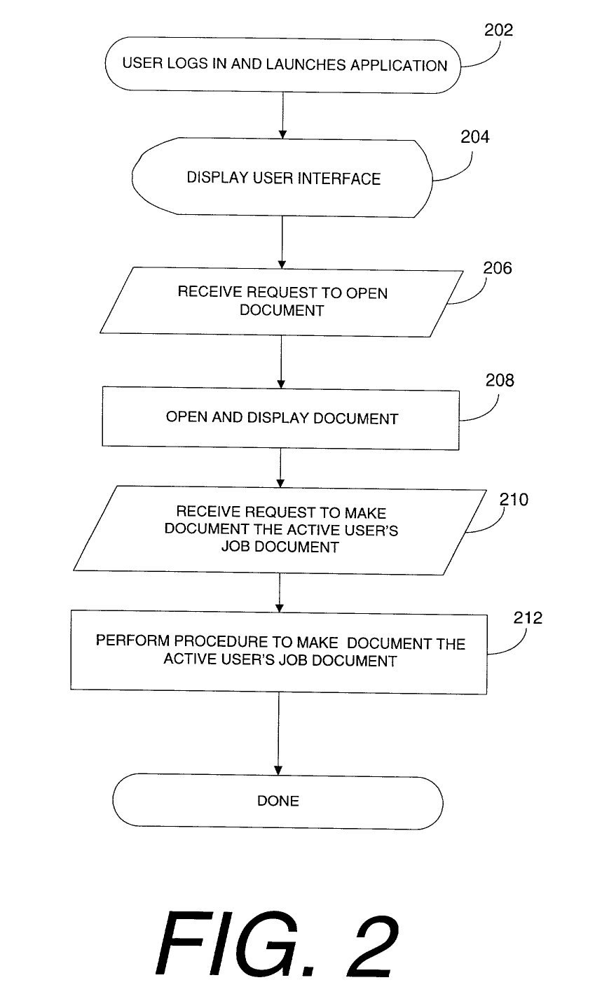

It is noted that one way for a user to designate a document to be his/her personal job document is by use of the word processing application 125. FIG. 2 is a flow diagram illustrating this functionality.

Referring now to FIG. 2, a user is assumed to log on to the PC 104 and then launch the application 125 (Step 202). Upon being launched, the application 125 operates to display an initial graphical user interface (GUI) (step 204). The GUI provides various menus and options. A user can interact with the GUI to create a new document or open an existing document. The GUI further allows a user to input a request to make the document, presently open in the application 125, the user's personal job document.

At step 206, the application 125 is assumed to receive a user request to open a particular document. At step 208, the application 125 responds to the request by opening and displaying the document.

At step 210, the user inputs a request to make the open document the user's personal job document. In response to this user request, the application 125 follows a pre-determined procedure to make the document the active user's personal job document (step 212). This may involve configuring the PC 104 so that Web content can access the document (by calling the PI function 126) whenever the present user is the active user.

It is noted that certain aspects of the procedure followed in step 212 may be governed by the Web imaging standard mentioned above. For example, the Web imaging standard may specify the formatting of job documents. The standard may specify, for example, that all job documents be filed in a portable document file (PDF) format. Other aspects of the procedure, however, may be governed by user preferences (e.g., the storage location of the job document). It is contemplated, for example, that the user may be given the option to store his/her personal job document locally or in a remote location.

Thus, step 212 may involve converting the document into a predetermined file format, (such as PDF) and then storing the document in a location associated with the active user. If the user's personal job document is stored by a remote server, the procedure followed in step 212 may involve configuring the remote server to operate cooperatively with the PI function 126 in an appropriate manner.

Turning again to FIG. 1A the primary printer 106 includes an embedded Web server 132. The embedded Web server 132 can serve Web content 136 to Web clients, via the network 110, upon receiving an appropriate request. The Web content 136 is assigned a unique URL. In some implementations, the Web content 136 may be generated dynamically. In other implementations, the Web content 136 is permanently stored in a local memory. For ease of discussion, the Web content 136 will be referred to as the “primary printer” (PP) Web content 136. The embedded Web server 132 may be referred to as the PP Web Server 132.

The alternate printer 108 includes an embedded Web server 142. The embedded Web server 142 can serve Web content 144 to Web clients via the network 110 upon receiving an appropriate request. The Web content 144 is assigned a unique URL. In some implementations, the Web content 144 may be generated dynamically upon receiving the request. In other implementations, the Web content 144 is permanently stored in a local memory. For ease of discussion, the Web content 144 will be referred to as the “alternate printer” (AP) Web content 144. The embedded WEB server 142 may be referred to as the AP Web server 142.

In general, the PP Web content 136 is for enabling clients to print a document using the primary printer 106. Thus, in this regard, the PP Web content 136 may be said to provide a Web based printing service. The AP Web content 144 is also intended to enable a client to print a document. The AP Web content 144, however, is for enabling a client to print a document using the alternate printer 108.

The PP Web content 136 and the AP Web content 144 both issue a “get_job_doc” call in order to access a document to print. Thus, for the case of the PC 104, the PP Web content 136 and the AP Web content 144 will each enable printing of the active user's job document. The PP Web content 136 enables printing of the active user's job document using the primary printer 106. The AP Web content 144 enables printing of the active user's job document using the alternate printer 108.

As will be discussed in greater detail below, the printing service provided by the PP Web content 136 may be referred to as the “primary printing service”. This is because user's of the PC 104 typically make use of the primary printer 106 to print their documents. The AP Web content 144 is used to provide a “back-up printing service”.

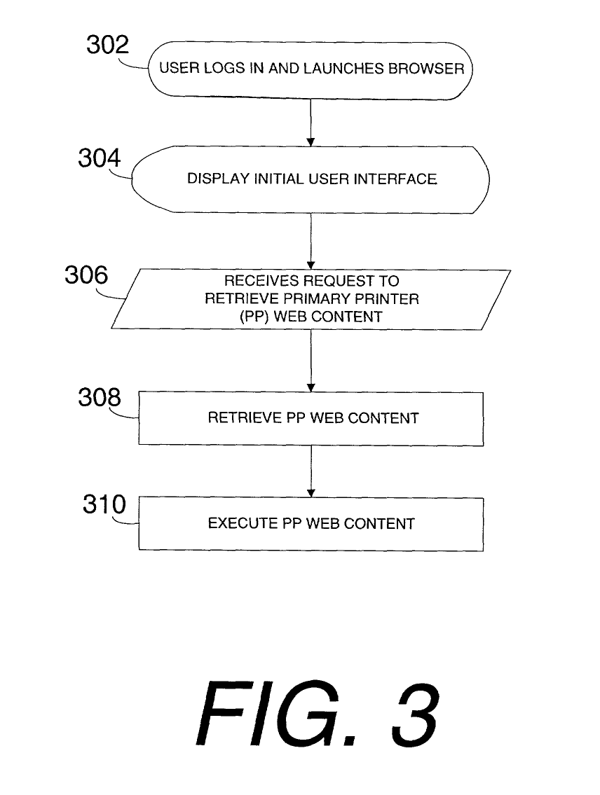

FIGS. 3-8 are flow diagrams illustrating how a user of the PC 104 can make use of the primary and the back-up printing services. It will be assumed in the following discussion that the user of the PC 104 has previously selected a document to be his/her personal job document.

Turning first to FIG. 3, the user logs into the PC 104 and launches the Web Browser 124 (step 302). Upon being launched, the Web Browser 124 displays an initial GUI (step 304).

The user can interact with the GUI to request the PP Web content 136. The Browser 124 receives this user request at step 306. In response, the Browser 124 retrieves the PP Web content 136 by sending an appropriate request to the embedded Web server 132 (step 308). At step 310, the Web Browser 124 executes the PP Web content.

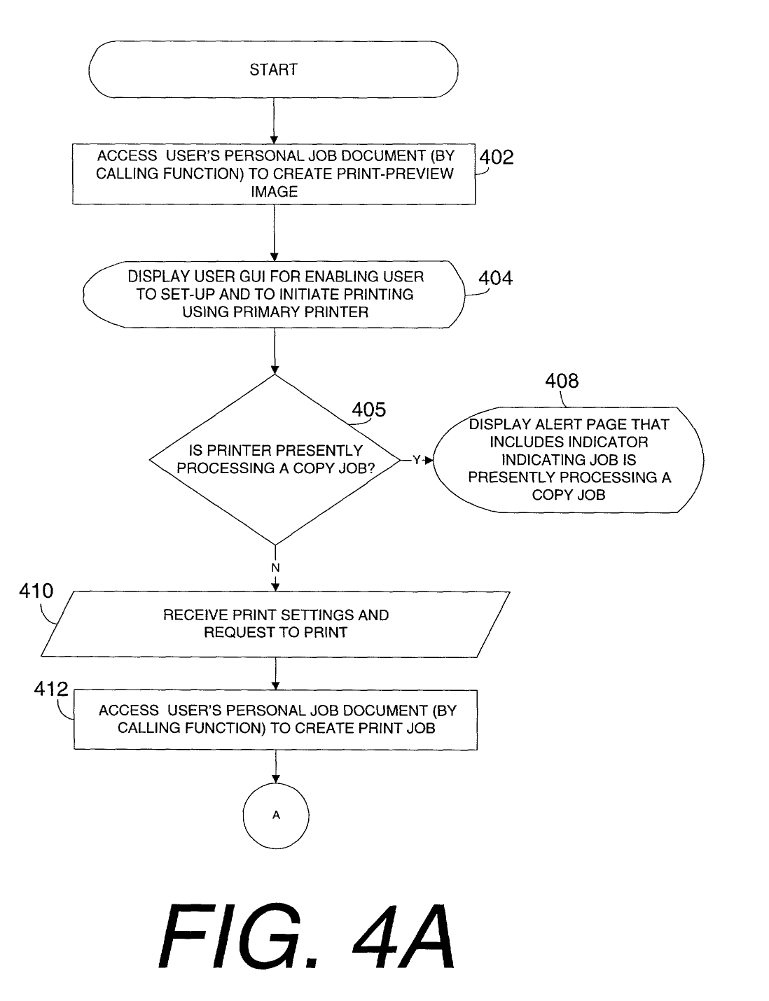

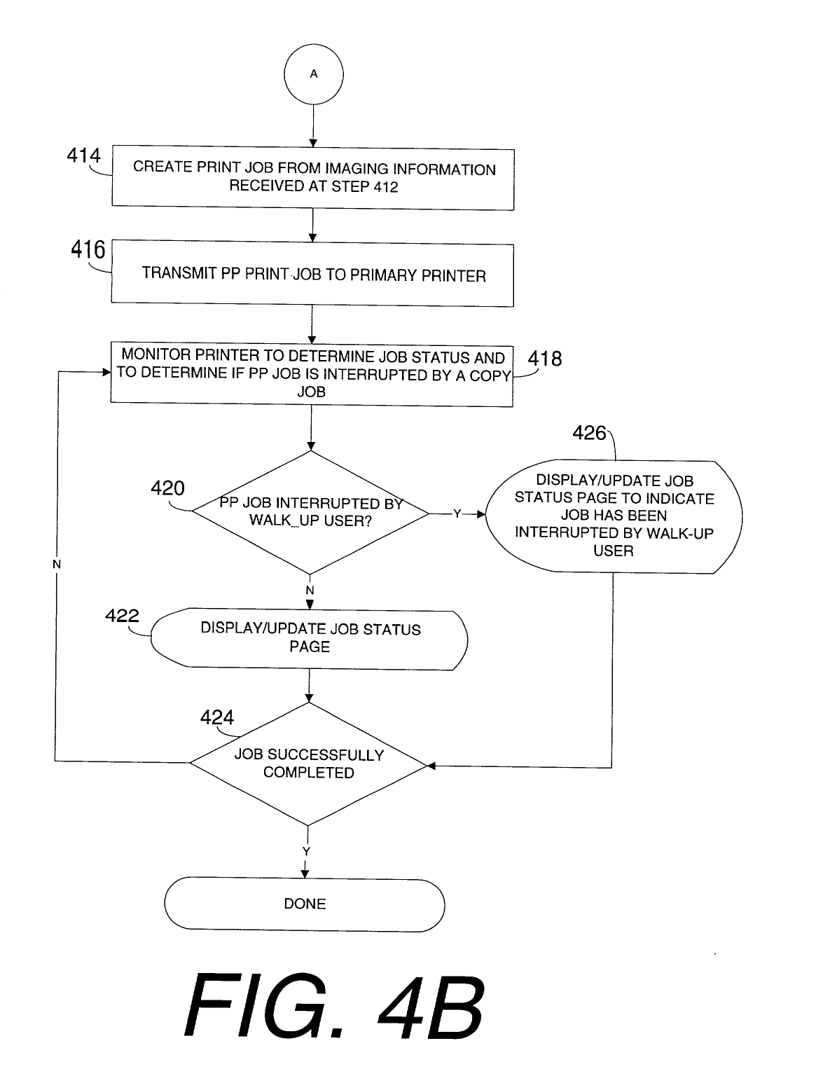

FIG. 4A and FIG. 4B is a flow diagram illustrating the operation of the PP Web content 136 at step 310. Turning now to FIG. 4A, the PP Web content 136 accesses the active user's personal job document by calling the PI function 126 (step 402).

Next, the PP Web content 136 operates to display a graphical user interface that allows the user to select various printing options that are offered specifically by the primary printer 106 (step 404). For ease of discussion, the user interface displayed at step 404 may be referred to as the “PP GUI”. In this example, the PP GUI is a Web page.

The PP GUI enables the user to select various print options that are offered by the primary printer 106 and to then initiate printing of the active user's personal job document. Additionally, the PP GUI also provides a print preview image of the active user's personal job document. The print preview image is based upon the imaging information received at step 402 and provides a visual representation of how the printer 106 will print the active user's personal job document.

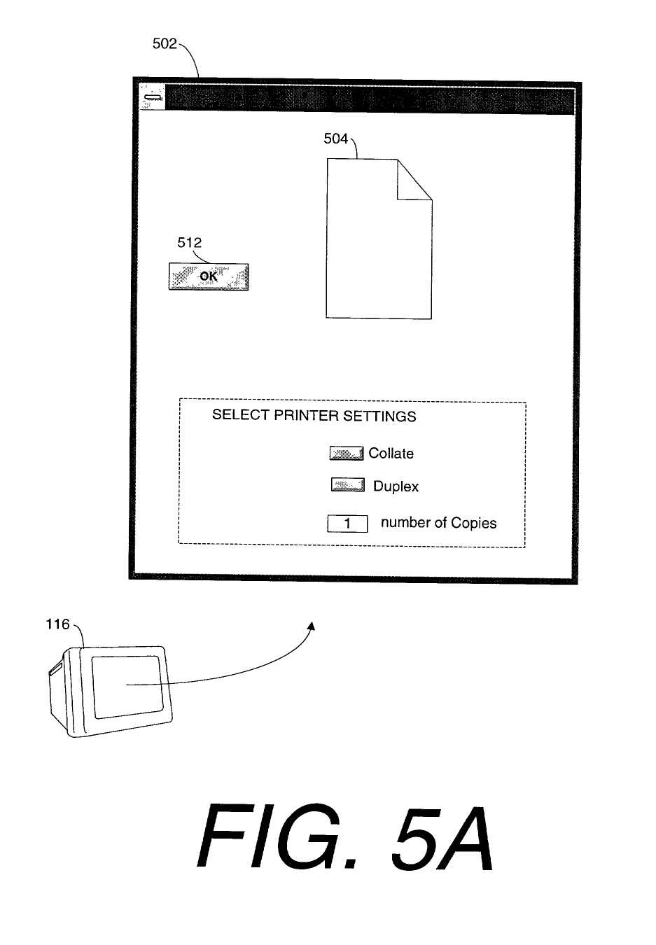

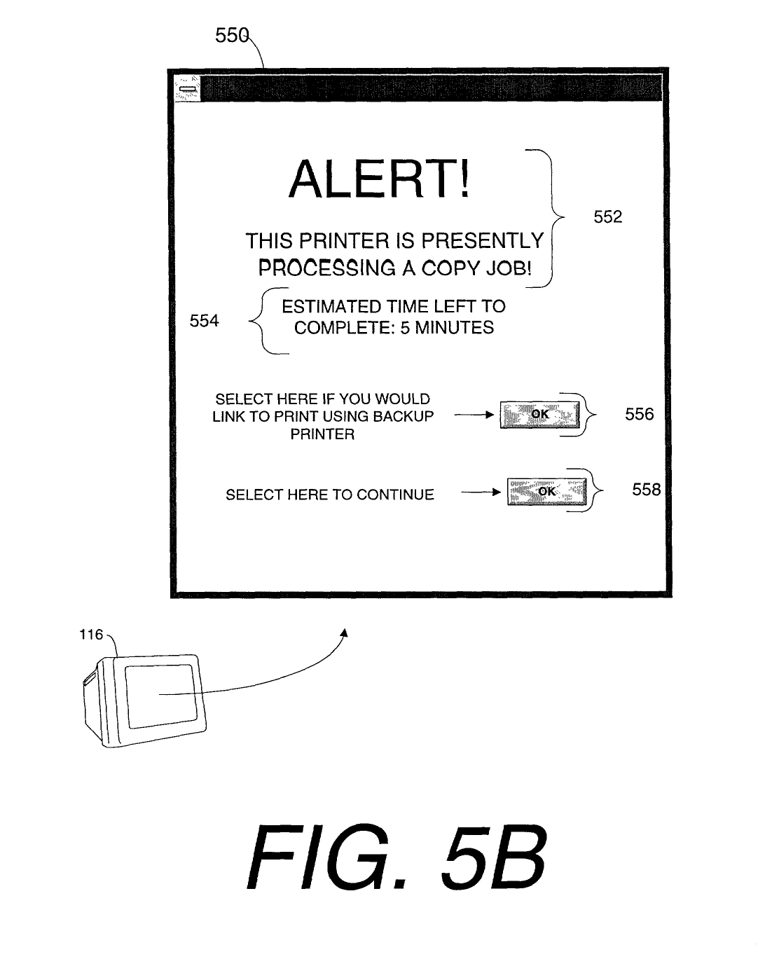

FIG. 5A provides an example of a PP GUI 502 that may be displayed at step 404 assuming the primary printer 106 offers document collation, duplex printing and multi-copy printing.

As shown, the PP GUI 502 includes a print preview image 504. The print preview image 504 provides a visual representation of how the active user's personal job document will be printed using the primary printer 106. The PP GUI 502 also allows the user to select various print options. For example, the PP GUI 502 allows the user to select a document collation option and a duplex printing option. In addition, the user can enter a number of copies he/she wishes to print. After the user has selected his/her desired options, the user can then request the active user's personal job document be printed by selecting an “OK” button 512.

Reference is again made to FIG. 4A. While the PP GUI is being displayed, the PP Web content 136 determines if the primary printer 106 is presently processing a copy job (step 405). In this embodiment, this step is accomplished by querying the printer 106. The printer 106 is configured to respond to the query by returning data that indicates whether the primary printer 106 is presently processing a copy job.

In this embodiment, if the primary printer 106 is presently processing a copy job, the primary printer 106 also may return an estimated amount of time left to complete the present copy job. The primary printer 106 may generate this estimate using any number of techniques known in the art. This estimate may be generated, for example, based upon the number of pages in the copy job, the copy settings and the known printing speed of the primary printer 106. In some instances, such as when the number of pages in the source document is unknown, it may not be possible to estimate the amount of time left to complete the current copy job.

If the PP Web Content 136 determines that the primary printer 106 is presently processing a copy job, the PP Web content 136 operates to cause another Web page to be displayed (step 405 and step 408). For ease of discussion, the Web page that is displayed at step 408 may be referred to as the “copy job alert” page.

In this embodiment, the copy-job alert page includes the following:

a) an indication that the primary printer 106 is presently processing a copy job;

b) estimated amount of time left to complete the copy job (if available); and

c) a hyperlink that refers to the AP Web content 144.

For ease of discussion, the hyperlink just mentioned that refers to the AP Web Content 144 may be referred to as the “copy-job alert page AP hyperlink”.

FIG. 5B provides an example of a copy-job alert page 550 that may be displayed at step 408. As shown, the copy job alert page 550 includes:

an indication 552 that the primary printer 106 is presently processing a copy job;

an indication 554 of the amount of time left to complete the copy job;

a “copy-job alert page” AP hyperlink 556; and

an “OK button” 558.

Selecting the AP hyperlink 556 causes the PC 104 to retrieve the AP Web content 144. As noted above, the AP Web content 144 enables the PC 104 to print the active user's personal job document by using the alternate printer 142.

Selecting the “OK” button 558 causes the PC 104 to remove the alert page 550. The user can then provide input to the PP GUI displayed at step 402 in order to set-up and initiate printing using the primary printer 106.

Reference is again made to FIG. 4A. In the next part of this discussion, it is assumed that the PP Web content 136 determines that the printer 106 is not processing a copy job (decision step 405). It is also assumed that the active user interacts with the PP GUI displayed at step 404 in order to select print options and initiate printing. The PC 104 receives this user input at step 410.

In response to this user input, the PP Web content 136 operates to access the active user's personal job document by again calling the PI function 126 (step 412). The PP Web content 136 then makes use of the imaging information received at step 412 and the user input received at step 410 to generate a print job (step 414). For ease of discussion, the print job created at this step will be referred to as the “PP print job”. The PP print job is suitable to print the active user's personal job document according to the print settings received at step 410.

At step 416, the PP Web content 136 causes the PP print job to be transmitted to the primary printer 106 via the network 110. The primary printer 106 receives the PP print job and begins processing it.

The PP Web content 136 then begins monitoring the primary printer 106 to determine the present status of the PP print job (step 418). For example, the PP Web content 136 monitors the primary printer 106 to determine the total number of pages that have been successfully printed. If the PP print job is a multi-copy job, the PP Web content 136 may also monitor the primary printer 106 to determine the total number of copies that have been successfully printed.

Additionally, the PP Web content 136 monitors the primary printer 106 to determine if a walk-up user has interrupted the processing of the PP print job.

If the processing of the PP print job is not interrupted by a walk-up user (step 420), the PP Web content 136 proceeds to display a Web page that indicates the present status of the PP print job to the user (step 422). For ease of discussion, the Web page displayed at step 422 may be referred to as the “job status page”. The job status page may indicate the total number of pages that have been successfully printed, the number of copies that have been successfully printed, etc.

The PP Web content 136 continues to periodically monitor the primary printer 106 to obtain the present status of the PP print job. The PP Web content 136 periodically updates the job status page to indicate the present status of the PP print job. This iterative procedure continues until either it is determined that the PP print job has been interrupted by a walk up user (step 420) or the PP print job is successfully printed (step 424).

If it is determined that the PP print job has been interrupted by a walk-up user (decision step 420), the PP Web content 136 proceeds to automatically update the job status page to include the following items (step 426):

an indicator that the processing of the PP print job has been interrupted by a walk-up user;

an estimated amount of time left to complete the copy job;

a hyperlink that refers to the AP Web content 144; and

the status of the PP job prior to it being interrupted.

For ease of discussion, the hyperlink that is provided by the job status page may be referred to herein as the “job status page AP hyperlink”.

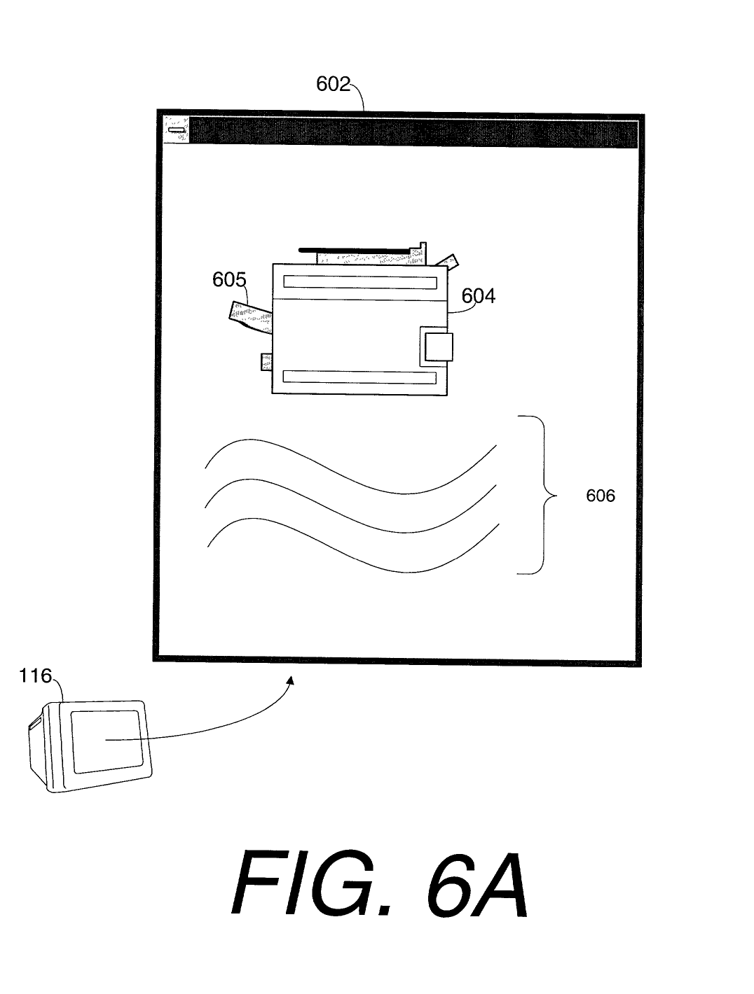

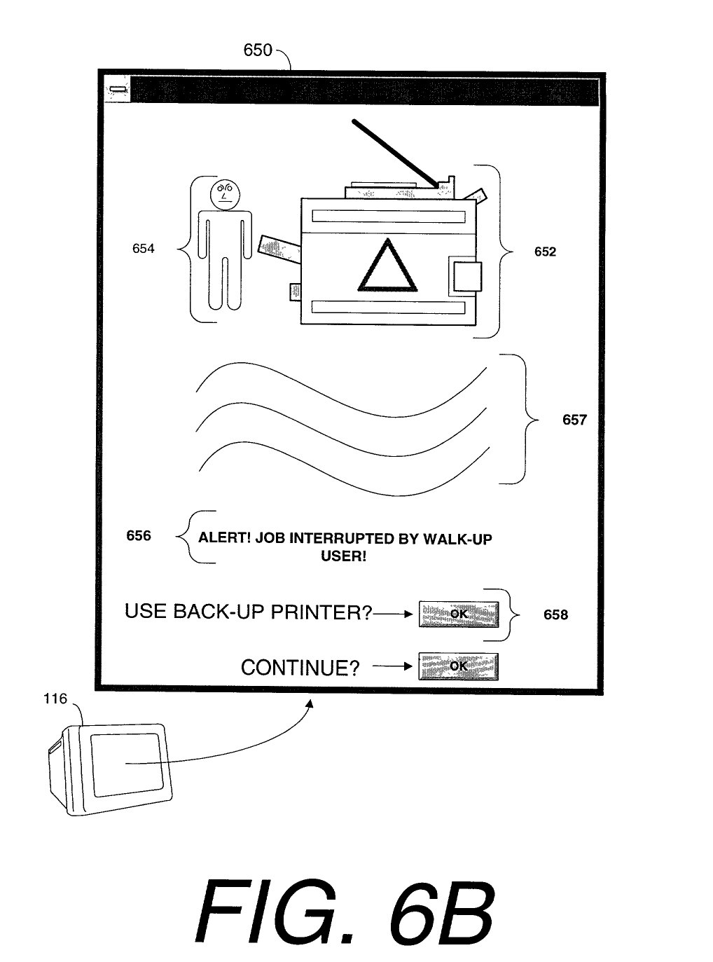

FIG. 6A provides an example of a job status page 602 that may be displayed at step 422. As noted above, the job status page displayed at step 422 is under the condition that the PP print job has not been interrupted by a walk-up user. As shown, the job status page 602 includes an icon (printer icon) 604 of the printer 106 and an information block 606. The printer icon 604 is a diagrammatical representation of the primary printer 106 In some implementations, the printer icon 604 is animated showing pages being placed in the output tray 605 thereby providing the user with a visual indication that the PP print job is printing normally.

The information block 606 indicates the present status of the PP print job. For example, in the case wherein the PP print job is a multi-copy job, the information block 606 may indicate the total number of pages that have been printed and the total number of copies successfully printed.

FIG. 6B provides an example of a job status page 650 that may be displayed by the PP WEB content 136 at step 426. As noted above, the job status page displayed at step 426 is under the condition that the PP print job has been interrupted by a walk-up user.

As shown, the job status page 650 includes a printer icon 652. The printer icon 652 includes a FIG. 654 standing next to the printer. The presence of the FIG. 654 as well as the text 656 indicates that a walk-up user has interrupted the processing of the PP print job.

In addition, the job status page 650 includes a text block 657 and a job status page AP hyperlink 658. The text block 657 indicates the present status of the PP print job just prior to it being interrupted.

In this embodiment, the “copy job alert page” AP hyperlink and the “job status page” AP hyperlink each specify the URL assigned to the AP Web content 144.

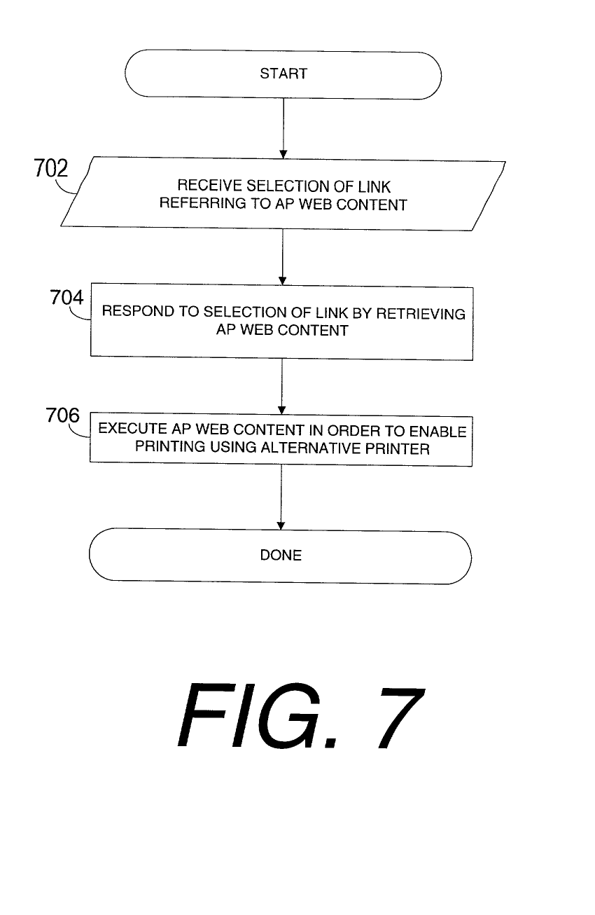

FIG. 7 is a flow diagram illustrating the operation of the browser 124 assuming a user selects either the copy job alert page AP hyperlink or the job status page AP hyperlink.

Referring now to FIG. 7, the browser 124 receives the user selection of the AP hyperlink (step 702). In response, the PC 104 retrieves the AP Web content 144 (step 704) and begins executing the AP Web content 144 (step 706).

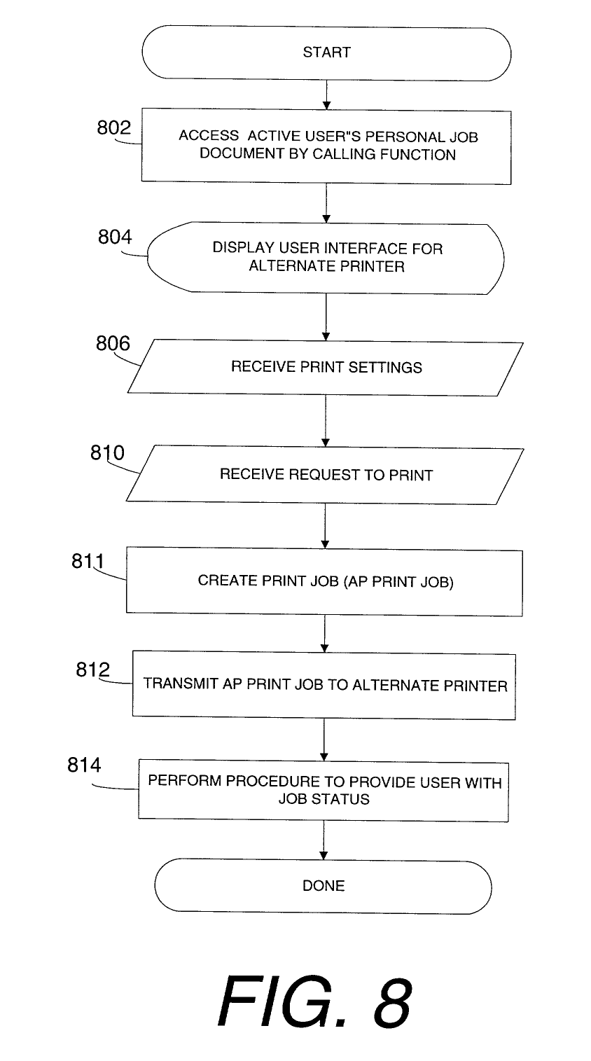

FIG. 8 is a flow diagram illustrating the operation of the AP Web content 144 at step 706. Turning now to FIG. 8, the AP Web content 144 operates to access the active user's personal job document by calling the PI function 126 (step 802). The PI function 126 responds by linking the AP WEB content 144 to the active user's personal job document. Thus, in this manner, the AP Web content 144 accesses the same document previously accessed by the PP Web content 136.

Next, the AP Web content 144 causes the PC 104 to display a graphical user interface (AP GUI) for printing the active user's personal job document using the alternate printer 108 (step 804). The AP GUI may be similar to the PP GUI. The AP GUI, however, is based upon the capabilities of the alternate printer 108.

It is assumed the user interacts with the AP GUI in order to select various print options and to then request the active user's personal job document be printed. The PC 104 receives this user input at step 806 and at step 810.

In response to this user input, the AP Web content 144 creates a print job (step 811). For ease of discussion, the print job created at step 811 will be referred to as the “AP print job”. The AP print job is suitable to cause the alternate printer 108 to print the active user's personal job document according to the print settings received at step 810.

At step 812, the AP Web content 144 causes the AP print job to be transmitted to the alternate printer 108. The alternate printer 108 receives the AP print job and begins processing the AP print job in an appropriate manner. In this example, the operation of the AP Web content 144 then halts. In other embodiments, the AP Web content 144 may proceed to perform steps similar to the ones depicted in FIG. 4B.

From the forgoing illustrative embodiment, it will be appreciated that a printing service provided by the invention offers a number of advantages. The primary printing service just described, for example, enables clients to print a document using a particular printer and provides a link to a back-up printing service in the event a walk-up user interrupts their job. Importantly, this gives the user the option to use the back-up printing service to re-print his/her document. The user, therefore, can decide (based upon his own personal preference) whether to use the back-up printing service. In the embodiment just described the primary printing service provides the user with information, via the job status page, that can be useful to the user in making this decision.

It is noted that there are a number of variations of the embodiment just described. In a first variation, for example, the AP Web content upon being downloaded immediately operates to print the active user's personal job document without further interaction from the user.

In a second variation, the PP Web content after sending the PP print job and upon detecting that the job has been interrupted by a walk-up user, operates to define a set of parameter values. The parameter values indicate the boundary between the portion of the PP print job that was successfully printed and the portion that was not. The “job status page” AP hyperlink is configured to, upon being selected, cause the browser 124 to transmit a request for the AP Web content, along with the parameters, to the AP embedded Web server 142.

The AP Web server 132 is configured to respond to the request and parameter values by generating AP Web content based upon the parameter values. The AP Web content enables the personal computer to print only the portion of the PP print job that was not successfully printed. In yet another variation, the AP Web content that is generated based upon these parameter values provide the user with the option of re-printing the entire PP print job or just the portion that did not print when the PP print job was interrupted.

In yet another variation, a user or system administrator selects the preferred “back-up” printing service. This preference may be stored locally by the client or may be stored in a remote storage location that is associated with the user. The PP Web content is configured to read the user's preference and to generate a link to this preferred back-up printing service when it is determined that the user's job has been interrupted by a walk-up user.

It is noted that the Web imaging standard described above represents just one model that enables a user to designate a document that he/she wishes to be accessed by Web based services. There are other models that can be used that also provide a user with this capability. For example, the operation of the client to allow a user to make a job document and to link the job document to Web content may be accomplished as a cooperative effort between two or more devices.

For example, the user may designate a job document to his/her personal job document by interacting with a remote server via his/her personal computer. According to one specific implementation, the remote server (document server) provides a user with a means for selecting a document to be his/her job document. Upon receiving the selection, the document server operates to link the selected document to an identifier (user ID) assigned to the user. The user ID may be the user's login name and password. The user ID is subsequently used to link the Web service to the user selected document. For example, when the user requests access to the service, the service provider (e.g., the printer Web server 132) requests the user input his/her ID. The service provider then makes use of this information to access the user's selected document from the document server. In this manner, therefore, the Web server is able to access the user's pre-selected job document and use that document to synthesize Web content (that enables document printing) based on that access. The Web content is then transmitted to the client.

It is important to also note that the present invention may be embodied in the form of a “computer readable medium” that has any one of the programs described above embodied therein. For example, a memory that stores (either temporarily or permanently) the PP Web content just described may be considered an embodiment of the invention. It is noted that the phrase “computer readable medium” can refer to any medium that can contain, store or propagate computer readable instructions. Thus, in this context, computer readable medium may refer to a medium such as a CD ROM or to signals that are used to communicate computer readable instructions (e.g., the PP Web content) over a network, such as the public Internet. A computer readable medium may also refer to a carrier wave.

Although several specific embodiments of the invention have been described and illustrated, the invention is not to be limited to specific forms or arrangements of parts so described and illustrated. For example, the flow diagrams described above indicate a specific order of execution. It is to be understood, however, that the order of execution may differ from that which is depicted. For example, the order of execution of two or more steps may be scrambled relative to the order shown. Also, two or more steps shown in succession may be executed concurrently or with partial concurrence. All such variations are within the scope of the present invention. Moreover, the invention is limited only by the claims and the equivalents thereof.

What is claimed is:

1. A computer implemented method, the computer being remotely connected to a first printer, the method comprising:
(a) displaying a graphical user interface (GUI) that enables a first user of the computer to provide input for initiating the printing of a document using the first printer; and
(b) if the first printer is processing a copy job when the computer is displaying the GUI, then automatically providing the first user with an indication that the first printer is processing a copy job.

2. The method of claim 1, further comprising:
(c) if the first printer is processing a copy job when the computer is displaying the GUI, then automatically providing the first user with an estimated amount of time left to complete the processing of the copy job.

3. The method of claim 1, further comprising:
(c) if the first printer is processing a copy job when the computer is displaying the GUI, then automatically providing the first user with a selectable link referring to a printing service, the printing service for enabling the computer to use a second printer to print the document.

4. The method of claim 1, further comprising:
(c) if the first printer is processing a copy job when the computer is displaying the GUI, then automatically providing the first user with an estimated amount of time left to complete the processing of the copy job; and
(d) if the first printer is processing a copy job when the computer is displaying the GUI, then automatically displaying a hyperlink referring to Web content for enabling the computer to print the document using a second printer.

5. The method of claim 1, further comprising:
(c) initiating printing of the document by the first printer; and
(d) if the printing of the document by the first printer is interrupted by a walk-up user of the first printer, then providing the first user with an indicator that indicates the printing of the document has been interrupted.

6. The method of claim 1, further comprising:
(c) initiating printing of the document by the first printer;
(d) if the printing of the document by the first printer is interrupted by a walk-up user of the first printer, then providing the first user with an indicator that indicates the printing of the document has been interrupted; and
(e) if the printing of the document by the first printer is interrupted by a walk-up user and the walk-up user submits a copy job, then providing the user with an amount of time left for the first printer to finish processing the copy job.

7. The method of claim 1, further comprising:
(c) initiating printing of the document by the first printer; and
(d) if the printing of the document by the first printer is interrupted by a walk-up user of the first printer, then providing the first user with an indicator that indicates the printing of the document has been interrupted.
(e) if the printing of the document by the first printer is interrupted by a walk-up user, then providing the user with a selectable link referring to a printing service that enables the computer to print at least a portion of the document using a second printer.

8. The method of claim 1, further comprising:
(c) initiating printing of the document by the first printer; and
(d) if the printing of the document by the first printer is interrupted by a walk-up user of the first printer, then providing the first user with an indicator that indicates the printing of the document has been interrupted; and
(e) if the printing of the document by the first printer is interrupted by a walk-up user, then displaying a hyperlink referring to Web content that enables the computer to print at least a portion of the document using a second printer.

9. A computer readable medium embodying a first program of instructions for causing a computer to perform method steps, the methods steps comprising:
(a) in response to first user input, initiating printing of a remote print job by a first printing device; and
(b) if the printing of the remote print job is interrupted by a walk-up user of the first printing device, then providing the first user with an indication that the printing of the remote print job has been interrupted by the walk-up user.

10. The computer readable medium of claim 9, wherein the method steps further comprising:
(c) displaying a GUI that enables the first user to provide the user input to initiate the printing of the remote print job; and
(d) if the first printer is processing a copy job when the computer displays the GUI, then automatically providing the first user with an indication that the first printing device is presently processing a copy job.

11. The computer readable medium of claim 9, wherein the method steps further comprising:
(c) if the printing of the remote print job is interrupted by a walk-up user of the first printing device, then displaying a selectable link referring to a second program of instructions that enables the computer to use an alternate printer to print at least a portion of a document described by the remote print job.

12. The computer readable medium of claim 9, wherein the method steps further comprising:
(c) if the printing of the remote print job is interrupted by a walk-up user of the first printing device, then displaying a selectable link referring to a second program of instructions located on a remote server, the second program for enabling the computer to print at least a portion of a document described by the remote print job by using an alternate printer.

13. The computer readable medium of claim 12, where the first program is Web content and the selectable link is a hyperlink.

14. The computer readable medium of claim 9, wherein the method steps further comprising:
(c) if the printing of the remote print job is interrupted by a walk-up user of the first printing device and the walk-up user submits a copy job to the print first printing device, then providing the first user with an indication of an amount of time to complete the processing of the copy job.

15. A first server, comprising:
a) means for receiving a request from a computer over a network; and
b) means for responding to the request by transmitting a first program of computer readable instructions to the computer, the first program enabling the computer to:
(i) display a GUI that enables a user of the computer to provide input for initiating a printing of a document using a first printer; and
(ii) automatically display an indicator indicating the first printer is processing a copy job if the first printer is presently processing a copy job when the GUI is displayed.

16. The first server of claim 15, wherein the first program further enables the computer to:
(iii) initiate the printing of the document by the first printer; and
(iv) provide the computer user with an indicator that indicates the printing of the document has been interrupted if the printing of the document is interrupted by a walk-up user of the first printer.

17. The first server of claim 16, wherein the first program further enables the computer to:
(v) automatically display a hyperlink referring to a second program located on a server if the printing of the document is interrupted by the walk-up user, the second program enables the computer to use an alternate printer to print the document.

18. The first server of claim 15, wherein the first server is an embedded Web server of the first printer.

19. A system, comprising:
a) a client; and
(b) a first server operable to receive a first request from the client and to respond thereto by serving a first program of instructions to the client; and wherein the first program of instructions enables the client to:
(i) display a GUI that enables a user of the computer to provide input for initiating the printing of a document using a first printing device; and
(ii) automatically providing the user with an indication that the first printer is processing a copy job if the first printer is processing a copy job when the computer displays the GUI.

20. The system of claim 19, further comprising:
(c) a second server operable to receive a second request from the client and to respond thereto by serving a second program of instructions to the client, the second program of instructions for enabling the client to print the document by using a second printing device; and
(d) wherein the first program of instructions enables the client to automatically display a selectable link to the second program if the first printer is processing a copy job when the computer displays the GUI.

21. The system of claim 19, wherein the first server is an embedded server of the first printing device.

22. The system of claim 19, wherein the server is an embedded Web server and the first printing device includes the embedded server.

23. The system of claim 19, wherein the client and the first server communicate over the Public Internet.
